(19) United States
(12) Patent Application Publication
(10) Pub. No.: US 2016/0024930 A1
(43) Pub. Date: Jan. 28, 2016

(54) TURBOMACHINE AIRFOIL

(71) Applicant: General Electric Company, Schenectady, NY (US)

(72) Inventors: Kelvin Rono Aaron, Simpsonville, SC (US); Craig Allen Bielek, Greenville, SC (US); Ross James Gustafson, Greenville, SC (US); Ariel Caesar Prepena Jacala, Travelers Rest, SC (US); Spencer Aaron Kareff, Simpsonville, SC (US); Matthew Robert Piersall, Greenville, SC (US); John Franklin Ryman, Greer, SC (US)

(21) Appl. No.: 14/340,059

(22) Filed: Jul. 24, 2014

(51) Int. Cl. F01D 5/14

(52) U.S. Cl. CPC F01D 5/145; F05D 2240/305; F05D 2230/00; F05D 2250/60

(57) ABSTRACT

A turbomachine airfoil includes a base portion and a blade portion extending from the base portion to a tip portion defining a radial span dimension. The blade portion includes a leading edge, a trailing edge, a pressure side and a suction side. An axial chord dimension is defined between the leading edge and the trailing edge. At least one protuberance is provided on the pressure side. The at least one protuberance extends from about 10% of the axial chord dimension to about 90% of the axial chord dimension.

### BACKGROUND OF THE INVENTION

The subject matter disclosed herein relates to the art of turbomachines and, more particularly, to a turbomachine airfoil.

Turbomachines typically include a compressor portion and a turbine portion. The compressor portion forms a compressed airstream that is introduced into the turbine portion. In a gas turbomachine, a portion of the compressed airstream mixes with products of combustion forming a hot gas stream that is introduced into the turbine portion through a transition piece. In a steam turbomachine, the hot gas stream may take the form of a high pressure steam flow. The hot gas stream expands through the turbine portion along a hot gas path.

The hot gas stream impacts turbomachine airfoils arranged in sequential stages along the hot gas path. The airfoils are generally connected to a wheel which, in turn, may be connected to a rotor. Typically, the rotor is operatively connected to a load. The hot gas stream imparts a force to the airfoils causing rotation. The rotation is transferred to the rotor. Thus, the turbine portion converts thermal energy from the hot gas stream into mechanical/rotational energy that is used to drive the load. The load may take on a variety of forms including a generator, a pump, an aircraft, a locomotive or the like.

### BRIEF DESCRIPTION OF THE INVENTION

According to one aspect of an exemplary embodiment, a turbomachine airfoil includes a base portion and a blade portion extending from the base portion to a tip portion defining a radial span dimension. The blade portion includes a leading edge, a trailing edge, a pressure side and a suction side. An axial chord dimension is defined between the leading edge and the trailing edge. At least one protuberance is provided on the pressure side. The at least one protuberance extends from about 10% of the axial chord dimension to about 90% of the axial chord dimension.

According to another aspect of an exemplary embodiment, a turbomachine includes a compressor portion, and a turbine portion operatively connected to the compressor portion. A turbomachine airfoil is arranged in one of the compressor portion and the turbine portion. The turbomachine airfoil includes a base portion and a blade portion extending from the base portion to a tip portion defining a radial span dimension. The blade portion includes a leading edge, a trailing edge, a pressure side and a suction side. An axial chord dimension is defined between the leading edge and the trailing edge. At least one protuberance is provided on the pressure side. The at least one protuberance extends from about 10% of the axial chord dimension to about 90% of the axial chord dimension.

According to yet another aspect of an exemplary embodiment, a method of forming a turbomachine airfoil includes forming a base portion and a blade portion, and creating at least one protuberance on a pressure side of the blade portion. The at least one protuberance extends from about 10% of an axial chord dimension to about 90% of the axial chord dimension of the blade portion.

These and other advantages and features will become more apparent from the following description taken in conjunction with the drawings.

### BRIEF DESCRIPTION OF DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a partial perspective view of a turbomachine airfoil, in accordance with an exemplary embodiment;

FIG. 2 is a schematic representation of a turbomachine including a turbomachine airfoil, in accordance with an exemplary embodiment;

FIG. 3 is a pressure side view of the turbomachine airfoil of, in accordance with another aspect of an exemplary embodiment;

FIG. 4 is a top view of the turbomachine airfoil of FIG. 3;

FIG. 5 is a pressure side view of a turbomachine airfoil, in accordance with another aspect of an exemplary embodiment; and

FIG. 6 is a pressure side view of a turbomachine airfoil, in accordance with yet another aspect of an exemplary embodiment.

The detailed description explains embodiments of the invention, together with advantages and features, by way of example with reference to the drawings.

### DETAILED DESCRIPTION OF THE INVENTION

A turbomachine system, in accordance with an exemplary embodiment, is indicated generally at 2, in FIG. 2. Turbomachine system 2 includes a turbomachine 4 having a compressor portion 6 operatively connected to a turbine portion 8 through a shaft 10. Compressor portion 6 is also fluidically connected to turbine portion 8 via a combustor assembly 12 including at least one combustor 14. Turbomachine system 2 is also shown to include an air inlet system 18 that delivers an airflow to an inlet (not separately labeled) of compressor portion 6. Air inlet system 18 may condition the airflow prior to introduction into compressor portion 6. Turbomachine system 2 is further shown to include a driven component 20 operatively connected to turbine portion 8. Driven component 20 may take the form of a generator, a pump or other mechanical load. Turbine portion 8 is still further shown to include a plurality of buckets 30 rotatably mounted within a housing (not separately labeled). Buckets 30 are arranged in a number of stages extending along a hot gas path (not separately labeled) of turbine portion 8.

Air enters air inlet system 18 and flows to compressor portion 6. The air is compressed and passed to combustor assembly 12. A portion of the air is passed into turbine portion 8 for cooling. In combustor assembly 12, the air is mixed with a fuel and or diluents to form a combustible mixture. The combustible mixture is combusted forming hot gases that pass from combustor assembly 12 to turbine portion 8 via a transition piece (not shown). The hot gases expand through turbine portion 8 at which time buckets 30 convert thermal energy into mechanical energy that drives driven component 20. The hot gases may pass from turbine portion 8 toward an exhaust system (also not shown).

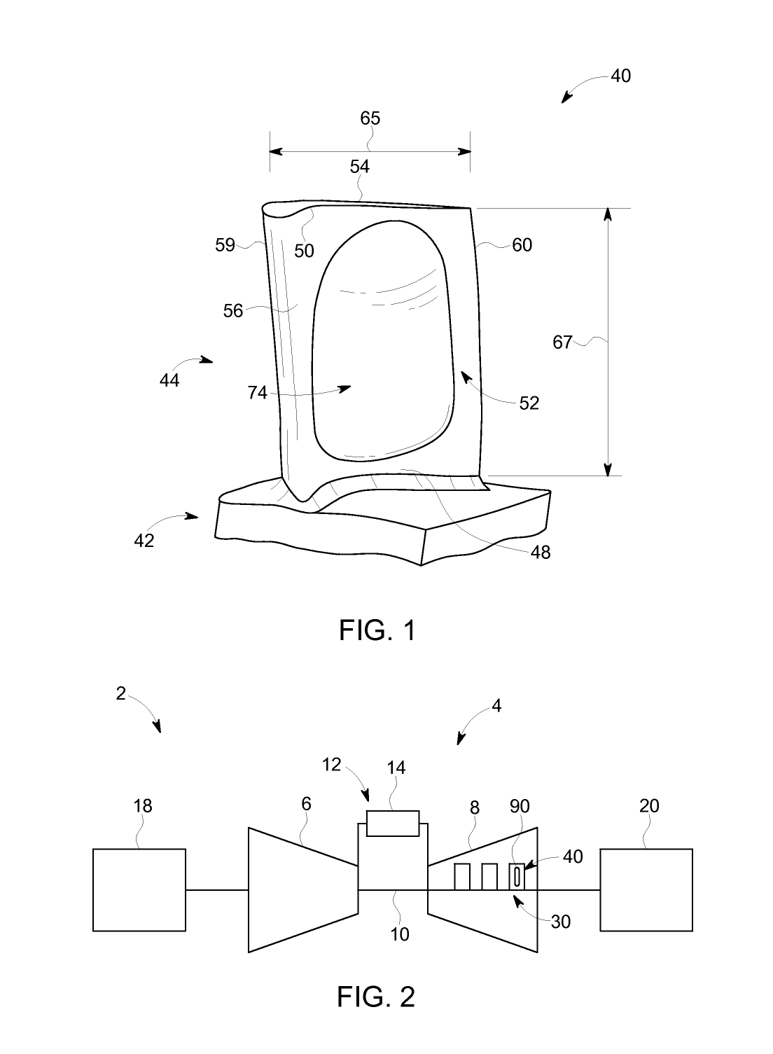

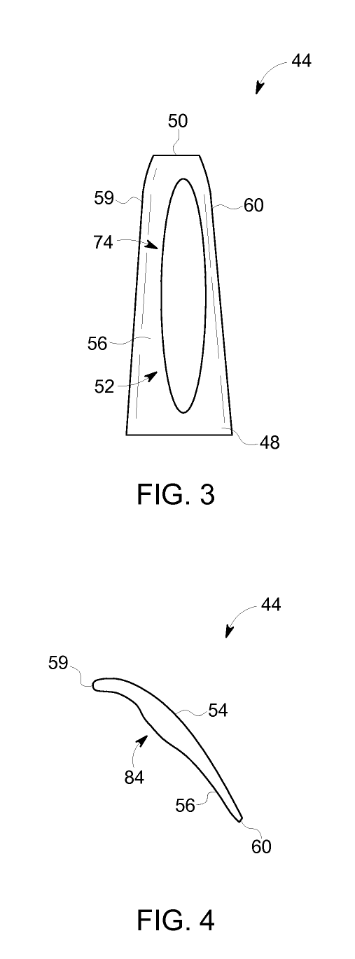

Reference will now follow to FIGS. 1 and 3 in describing a turbomachine airfoil or bucket 40 that may be included in plurality of buckets 30. Turbomachine airfoil 40 may be arranged in any one of the plurality of stages (not separately labeled) of turbine portion 8. Turbomachine airfoil 40 includes a base portion 42 that may be operatively coupled to a rotor wheel (not shown) in turbine portion 8 and an airfoil portion 44. Airfoil portion 44 extends from a first or base end portion 48 to a second or tip end portion 50. Base end portion 48 is formed with, and extends radially outwardly of, base portion 42. Turbomachine airfoil 40 includes an airfoil surface 52 having a suction side 54 and a pressure side 56. Airfoil surface 52 also includes a leading or upstream edge 59 and a trailing or downstream edge 60. Airfoil portion 44 includes an axial chord dimension 65 defined between leading edge 59 and trailing edge 60 and a radial span dimension 67 defined between base end portion 48 and tip end portion 50.

In accordance with an exemplary embodiment, airfoil portion 44 includes a protuberance 74. In accordance with an aspect of an exemplary embodiment, protuberance 74 is arranged on pressure side 56 of airfoil portion 44. In further accordance with an exemplary embodiment, protuberance 74 extends from about 10% of axial chord dimension 65 to about 90% of axial chord dimension 65. In accordance with another aspect of an exemplary embodiment, protuberance 74 extends from about 20% of axial chord dimension 65 to about 80% of axial chord dimension 65. In still further accordance with an aspect of the exemplary embodiment, protuberance 74 extends from about 5% of radial span dimension 67 to about 100% of radial span dimension 67. In accordance with yet still another aspect of an exemplary embodiment, protuberance 74 extends from about 50% of radial span dimension 67 to about 95% of radial span dimension 67. Protuberance 74 may also extend from about 50% of radial span dimension 67 to about 90% of radial span dimension 67.

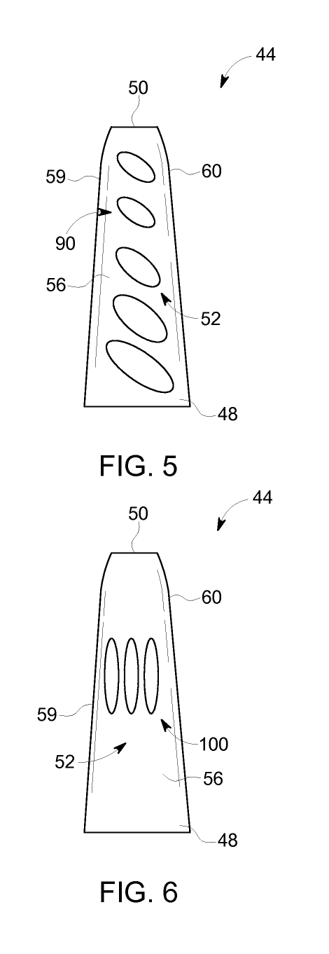

FIG. 4, wherein like reference numbers represent corresponding parts in the respective views, illustrates a protuberance 84 extending between about 25% of axial chord length 65 to about 75% of axial chord length 65. FIG. 5, wherein like reference numbers represent corresponding parts in the respective views, illustrates a plurality of protuberances 90 extending between about 10% of axial chord dimension 65 to about 90% of axial chord dimension 65 and between about 5% of radial span dimension 67 to about 100% of radial span dimension 67. FIG. 6 wherein like reference numbers represent corresponding parts in the respective views illustrates a plurality of protruberances 100 extending across radial span dimension 67 from about 5% of radial span dimension 67 to about 90% of radial span dimension 67.

At this point it should be understood that the exemplary embodiments describe a turbomachine airfoil having a protuberance extending between an axial chord length and a radial span length of an airfoil surface. The shape of the protuberance may vary and could include humps, bumps, ridges, and the like. Further, the number and location of the protuberances may vary. The protuberance(s) form a conditioning zone on the turbomachine airfoil. The conditioning zone enhances aeromechanics and/or aeroelastics of the blade. For example, the protuberance(s) may improve blade stability allowing for longer airfoils that would not require a part span shroud. Various protuberances have been shown to significantly increase bucket stability. In addition, the protuberance enables frequency tuning of the bucket to avoid resonant mode excitation while, at the same time, reducing or maintaining rotating pull load.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A turbomachine airfoil comprising:
a base portion;
a blade portion extending from the base portion to a tip portion defining an radial span dimension, the blade portion including a leading edge, a trailing edge, a pressure side and a suction side, an axial chord dimension being defined between the leading edge and the trailing edge; and
at least one protuberance provided on the pressure side, the at least one protuberance extending from about 10% of the axial chord dimension to about 90% of the axial chord dimension.

2. The turbomachine airfoil according to claim 1, wherein the at least one protuberance extends from about 25% of the axial chord dimension to about 75% of the axial chord dimension.

3. The turbomachine airfoil according to claim 1, wherein the at least one protuberance includes a plurality of protuberances extending across the axial chord dimension.

4. The turbomachine airfoil according to claim 1, wherein the at least one protuberance includes a plurality of protuberances extending across the radial span dimension.

5. The turbomachine airfoil according to claim 1, wherein the at least one protuberance extends from about 5% of the radial span dimension to about 100% of the radial span dimension.

6. The turbomachine airfoil according to claim 5, wherein the at least one protuberance extends from about 50% of the radial span dimension to about 95% of the radial span dimension.

7. The turbomachine airfoil according to claim 6, wherein the at least one protuberance extends from about 50% of the radial span dimension to about 90% of the radial span dimension.

8. The turbomachine airfoil according to claim 1, wherein the turbomachine airfoil comprises a turbine bucket.

9. A turbomachine comprising:
a compressor portion;
a turbine portion operatively connected to the compressor portion; and
a turbomachine airfoil arranged in one of the compressor portion and the turbine portion, the turbomachine airfoil including
a base portion;
a blade portion extending from the base portion to a tip portion defining a radial span dimension, the blade portion including a leading edge, a trailing edge, a pressure side and a suction side, an axial chord dimension being defined between the leading edge and the trailing edge; and
at least one protuberance provided on the pressure side, the at least one protuberance extending from about 10% of the axial chord dimension to about 90% of the axial chord dimension.

10. The turbomachine according to claim 9, wherein the at least one protuberance extends from about 25% of the axial chord dimension to about 75% of the axial chord dimension.

11. The turbomachine according to claim 9, wherein the at least one protuberance includes a plurality of protuberances extending across the axial chord dimension.

12. The turbomachine according to claim 9, wherein the at least one protuberance includes a plurality of protuberances extending across the radial span dimension.

13. The turbomachine according to claim 9, wherein the at least one protuberance extends from about 5% of the radial span dimension to about 100% of the radial span dimension.

14. The turbomachine according to claim 13, wherein the at least one protuberance extends from about 50% of the radial span dimension to about 95% of the radial span dimension.

15. The turbomachine according to claim 14, wherein the at least one protuberance extends from about 50% of the radial span dimension to about 90% of the radial span dimension.

16. The turbomachine according to claim 9, wherein the turbomachine airfoil comprises a turbine bucket.

17. A method of forming a turbomachine airfoil comprising:
forming a base portion and a blade portion; and
creating at least one protuberance on a pressure side of the blade portion, the at least one protuberance extending from about 10% of an axial chord dimension to about 90% of the axial chord dimension of the blade portion.

18. The method of claim 17, wherein the at least one protuberance includes forming a plurality of protuberances on the one of the pressure side.

19. The method of claim 18, wherein forming a plurality of protuberances on the pressure side includes forming a plurality of protuberances across one of the axial chord dimension and the radial span dimension.

20. The method of claim 17, wherein the at least one protuberance includes forming the at least one protuberance between about 5% of a radial span dimension to about 100% of the radial span dimension.
